(19) United States
(12) Patent Application Publication
(10) Pub. No.: US 2013/0292616 A1
(43) Pub. Date: Nov. 7, 2013

(54) TOOL FOR OPENING FROZEN CAR DOORS

(71) Applicants: Kevin Paul Kitzman, Aberdeen, NC (US); Casey Paul Kitzman, Aberdeen, NC (US)

(72) Inventors: Kevin Paul Kitzman, Aberdeen, NC (US); Casey Paul Kitzman, Aberdeen, NC (US)

(21) Appl. No.: 13/659,843

(22) Filed: Oct. 24, 2012

Related U.S. Application Data
(60) Provisional application No. 61/643,672, filed on May 7, 2012.

(51) Int. Cl. B66F 15/00

(52) U.S. Cl. CPC B66F 15/00
USPC 254/120

(57) ABSTRACT

A tool assists a user to open a frozen car door without causing damage to the car door or door frame. The tool can be carried on a key ring so as to be readily available to the user. The tool can be made in a hook shape with smooth edges and with a resin or plastic material that will not damage the vehicle like a conventional metal screwdriver may cause.

### CROSS-REFERENCE TO RELATED APPLICATION

This application claims the benefit of priority of U.S. provisional application No. 61/643,672, filed May 7, 2012, the contents of which are herein incorporated by reference.

### BACKGROUND OF THE INVENTION

The present invention relates to hand tools and, more particularly, to a tool that can be used to pry car doors open with they are frozen with ice.

Freezing rain, rain followed by freezing temperatures, car washes where temperatures drop below freezing and other such events can cause a car door to freeze shut. Frozen car doors can be hard to open without causing damage to the car or to the user's body. For example, a person often bangs their hand along a frozen car door or tries to use a screwdriver or other instrument that can cause damage to the car. Another solution involves trying an opposite side door to gain access inside the car and kicking out the car door. However, this method can prove difficult to position inside the car, especially with center consoles, and this method can cause damage, dirt, scuff marks or the like to the inside surface of the car door.

As can be seen, there is a need for an improved method and device for allowing a person to open a car door that may be frozen in a closed position.

### SUMMARY OF THE INVENTION

In one aspect of the present invention, a car door opening tool comprises a handle portion; a pry nose attached to a first end of the handle portion; and a key ring hole disposed on a second, opposite end of the handle portion.

In another aspect of the present invention, a car door opening tool comprises a handle portion; a pry nose attached to a first end of the handle portion; a key ring hole disposed on a second, opposite end of the handle portion; and a key ring disposed through the key ring hole, wherein the pry nose extends from the handle portion at an angle from about 85 to about 95 degrees; and the handle is from about 3 inches to about 6 inches in length.

In a further aspect of the present invention, a method for opening a frozen car door comprises inserting a pry nose of a car door opening tool into a space between a car door and a car door frame; pulling a handle portion attached, at a first end thereof, to the pry nose; and urging the car door to move away from the car door frame to unfreeze the frozen car door.

These and other features, aspects and advantages of the present invention will become better understood with reference to the following drawings, description and claims.

### BRIEF DESCRIPTION OF THE DRAWINGS

FIG. 1 is a perspective view of a car door opening tool attached to a key chain, according to an exemplary embodiment of the present invention;

FIG. 2 is a rear perspective view of the car door opening tool of FIG. 1;

FIG. 3 is a front perspective view of the car door opening tool of FIG. 1; and

FIG. 4 is partial cross-sectional perspective view showing the car door opening tool of FIG. 1 in use to open a car door.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a tool to assist a user to open a frozen car door without causing damage to the car door or door frame. The tool can be carried on a key ring so as to be readily available to the user. The tool can be made in a hook shape with smooth edges and with a resin or plastic material that will not damage the vehicle like a conventional metal screwdriver may cause.

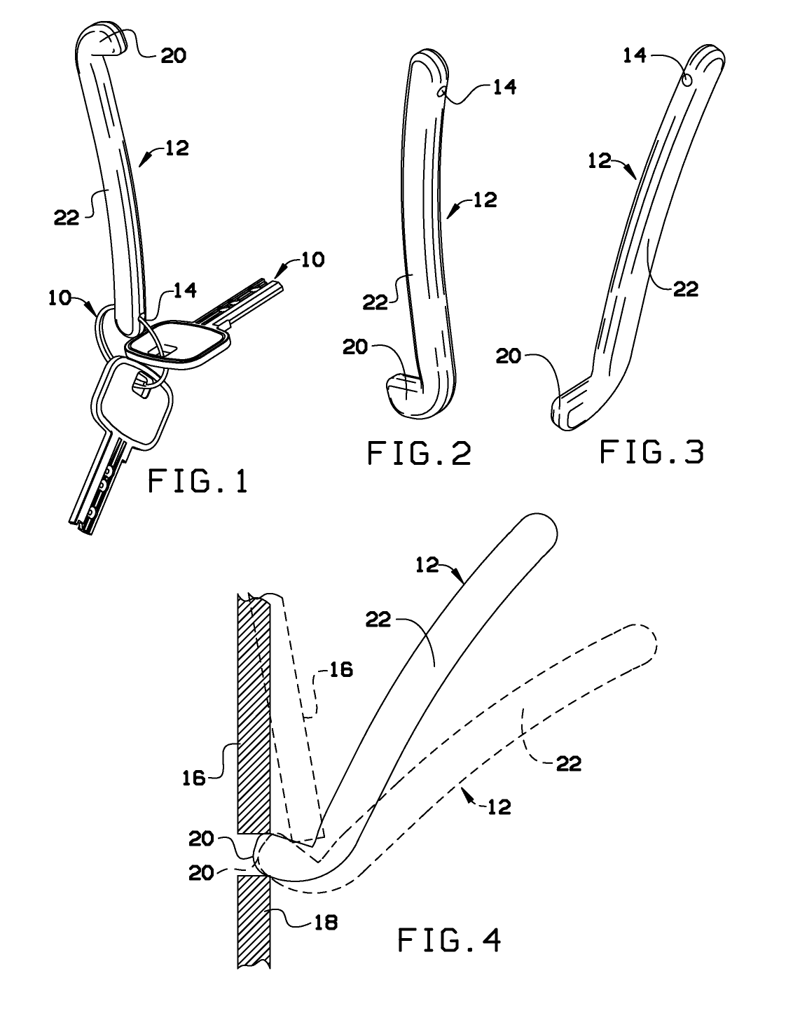

Referring now to FIGS. 1 through 3, a car door opening tool 12 can include a handle portion 22 having a pry nose 20 attached to a first end thereof. The pry nose 20 can extend from the first end of the handle portion 22 at an angle from about 60 to about 120 degrees, typically about 85 to about 90 degrees. The pry nose 20 can attach to the handle portion 22 with a smooth exterior curved surface.

A key ring hole 14 can be formed on a second, opposite end of the handle portion 22. A key ring and/or keys 10 can attach to the key ring hole 14. The car door opening tool 12 can have an overall length from 3 inches to about 6 inches, allowing the tool 12 to be conveniently carried along with the user's keys 10. This configuration allows the tool 12 to be readily at hand when its use may be needed. The tool 12 can be engraved, made in various colors (such as school or team colors), or other personalized for the user.

Referring now to FIG. 4, to use the car door opening tool 12, a user can simply insert the pry nose 20 of the tool 12 between a car door 16 (a pry surface) and a car door frame 18 (a stationary leverage surface). The user can hold the door handle open and move the handle portion 22 away from the car door 16, causing the car door 16 to be pried open. Typically, only a small amount of movement in the open direction (toward the dashed line in FIG. 4) will cause the frozen door to unfreeze, allowing the user to continue to easily pull the car door open.

As discussed above, the car door opening tool 12 can be made from a material that can be used to pry open car doors without causing damage thereto. The material can be designed with smooth surfaces so as not to create scratches or dents in the car door 16 or door frame 18. The material can be selected from resin, plastic, rubber, or similar materials.

It should be understood, of course, that the foregoing relates to exemplary embodiments of the invention and that modifications may be made without departing from the spirit and scope of the invention as set forth in the following claims.

What is claimed is:

1. A car door opening tool comprising:
a handle portion;
a pry nose attached to a first end of the handle portion; and
a key ring hole disposed on a second, opposite end of the handle portion.

2. The car door opening tool of claim 1, wherein the pry nose extends from the handle portion at an angle from about 85 to about 95 degrees.

3. The car door opening tool of claim 1, wherein the handle is from about 3 inches to about 6 inches in length.

4. The car door opening tool of claim 1, further comprising a key ring disposed through the key ring hole.

5. A car door opening tool comprising:
a handle portion;
a pry nose attached to a first end of the handle portion;
a key ring hole disposed on a second, opposite end of the handle portion; and
a key ring disposed through the key ring hole, wherein
the pry nose extends from the handle portion at an angle from about 85 to about 95 degrees; and
the handle is from about 3 inches to about 6 inches in length.

6. The car door opening tool of claim 5, wherein the pry nose attaches to the handle with a smooth exterior curved surface.

7. A method for opening a frozen car door, comprising:
inserting a pry nose of a car door opening tool into a space between a car door and a car door frame;
pulling a handle portion attached, at a first end thereof, to the pry nose; and
urging the car door to move away from the car door frame to unfreeze the frozen car door.

8. The method of claim 7, further comprising carrying the car door opening tool with keys via a key ring attaching the keys to the car door opening tool through a key ring hole formed in a second, opposite end of the handle portion.
